(19) United States
(12) Patent Application Publication
(10) Pub. No.: US 2008/0264926 A1
(43) Pub. Date: Oct. 30, 2008

(54) COOKING RANGE

(76) Inventor: ZHENG PENG, Ypsilanti, MI (US)

Correspondence Address: ZHAOXIA XU, 4694 SYCAMORE DR., YPSILANTI, MI, 48197, US

(21) Appl. No.: 11/739,496

(22) Filed: Apr. 24, 2007

(51) Int. Cl. H05B 3/68; F24C 15/10

(52) U.S. Cl. 219/452.11; 126/218

(57) ABSTRACT

A cooking range (100). Range (100) comprises a cabinet (50) for housing an oven, a range top (64) installed on top of cabinet (50) for providing a cooking platform, at least one stove base (112) installed on top of range top (64) for supporting cooking accessories, a control panel (60) for controlling the operation of range (100), a cooking device (80) disposed on top of range top (64) for cooking food, an adapting member (110) engaged with cooking device (80) for adapting cooking device (80) to stand on stove base (112), a thermostat (122) installed on stove base (112) and adapted to detect and control the temperature of the bottom of cooking device (80). As cooking device (80) is properly installed on stove base (112) the electrical terminals of cooking device (80) is removably engaged with an electrical port (112c) on stove base (112).

### TECHNICAL FIELD AND INDUSTRIAL APPLICABILITY OF THE INVENTION

This invention generally relates to cooking ranges. More specifically, this invention relates to a cooking range that includes a universal cooking device.

### BACKGROUND OF THE INVENTION

Traditional cooking ranges, electrical or gas, have a cabinet with a range top, on which are disposed multiple cooking stoves. The cabinet further includes a door, which provides access to an oven. Also a control panel extends from the cabinet at the rear of the range top and includes variety of user input devices for controlling the operation of the cooking stoves and the oven. Cooking ranges have been a major household appliance at home to meet consumers' daily cooking needs.

However, a user has to attend cooking processes with great efforts to avoid such accidents as spillage, overheating of food, etc. One of the major disadvantages of traditional cooking ranges is tack of convenient, accurate, and reliable temperature control for the range top to fit into various cooking techniques, such as warming, stow cooking, simmering, sautéing, braising, deep frying, etc.

Many stand-atone small kitchen appliances have been developed and are on the market to overcome the shortcoming of cooking ranges to save time and efforts in cooking for consumers. Such stand-alone small kitchen appliances include slow cookers, deep fryers, hot pots, fondue pots, grill pans, skillet woks, kitchen kettles, pressure cookers, etc. These small kitchen appliances have been long known as preferred devices for consumers to cook food. The problem is that consumers have limited kitchen space for these appliances in their home. The high cost associated with buying these small kitchen appliances, in addition to cooking ranges, is another issue. Therefore, there is a need for kitchen appliance consolidation. One of many ways for this appliance consolidation is to use cooking ranges as a base. But how to incorporate those functions of small appliances into a cooking range remains a technical challenge from structural design point of view. Some previous attempts are demonstrated in the following two issued US patents.

U.S. Pat. No. 5,910,265, issued to Baker et al., on Jun. 8, 1999, discloses an electric range with a reversible heating tube. When the reversible heating tube is positioned in a reversed position, the heating tube is farther away from the bottom of a pan or pot and can be used for slow cooking.

U.S. Pat. No. 6,078,029, issued to Trujillo et al., on Jun. 20, 2000, teaches regarding a cooking range system for maximizing the contact between the heating coil and a cooking pot or pan being heated. The cooking range system includes a range top having a cooking well therein.

Therefore, it remains desirable to provide a cooking range that can be used to cook food with minimum attendance, that can more precisely and reliably control the cooking temperature of the range top for specific applications, and that is innovative in design, such that it includes a cooking device that can be conveniently changed for different cooking techniques and that is removable for cleaning after use and dishwasher safe.

### BRIEF SUMMARY OF THE INVENTION

Accordingly, the present invention is a cooking range. This cooking range comprises a cabinet having a door for housing an oven, a range top installed on top of the cabinet for supporting cooking stoves, at least one stove base installed on top of the range top for supporting a cooking device, an adapting member engaged with the cooking device for adapting the cooking device to removably stand on the stove base, and a thermostat installed on the stove base and adapted to detect and control the temperature of the bottom of the cooking device. As the cooking device is installed in position on the stove base, the electrical terminals of the cooking device is operationally connected with an electrical port on the stove base for supplying electrical power to the cooking device.

Accordingly, the followings are some of the objects, features, and advantages of the present invention.

It is an object of the present invention to establish a bridge between large appliances, such as cooking ranges, and small kitchen appliances, such as slow cookers, deep fryers, fondue pots, kitchen kettles, skillets, grills, roasters, etc., leveraging cooking range resources currently in consumers home.

It is another object of the present invention to provide a cooking range that allows a user to exchange cooking devices for various cooking applications, such as slow cooking, simmering, boiling, deep frying, braising, sautéing, etc., with automatic and more precise temperature control.

It is a feature of the present invention that this cooking range includes at least one stove base installed on top of a range top for removably receiving an cooking device for various cooking applications.

It is another feature of the present invention that a thermostat is installed on the stove base and removably engaged with the bottom of the cooking device for detecting and controlling the temperature of the bottom of the cooking device, whereby more accurate temperature control can be achieved for various cooking techniques.

It is a further more feature of the present invention that an adapting member is provided for adapting the cooking device to removably stand on the stove base. The upper end of the adapting member is fixedly engaged with the cooking device and the lower end is extended downward to a predetermined distance for adapting the cooking device to stand on the stove base for use of cooking or on a horizontal surface for use of serving food.

It is a still further more feature of the present invention that a heating tube is fixedly installed on the bottom of the cooking device. By directly installing the heating tube on the bottom heating efficiency is significantly enhanced and the cost for manufacturing is significantly reduced.

It is an advantage of the present invention that various cooking devices share one common stove base installed on the range top, such that consumers do not have to buy many small kitchen appliances for their cooking needs. Consumers buy multiple cooking devices for various applications, which are much less expensive.

Further more features and advantages of the present invention will be readily appreciated, as the same becomes better understood after reading the subsequent description when considered in connection with the non-limiting accompanying drawings.

### BRIEF DESCRIPTION OF THE DRAWINGS

FIG. 1 illustrates a perspective view of an embodiment of the present invention, a cooking range 100.

FIG. 2 illustrates a cross-sectional view of cooking device 80.

FIG. 3 illustrates a bottom view of container 102.

FIG. 4 illustrates a top view of stove base 112.

FIG. 5 illustrates another cross-sectional view of cooking device 80.

FIG. 6 illustrates a cross-sectional view of an alternative design of stove base 112, a stove base 212.

### DETAILED DESCRIPTION OF THE INVENTION

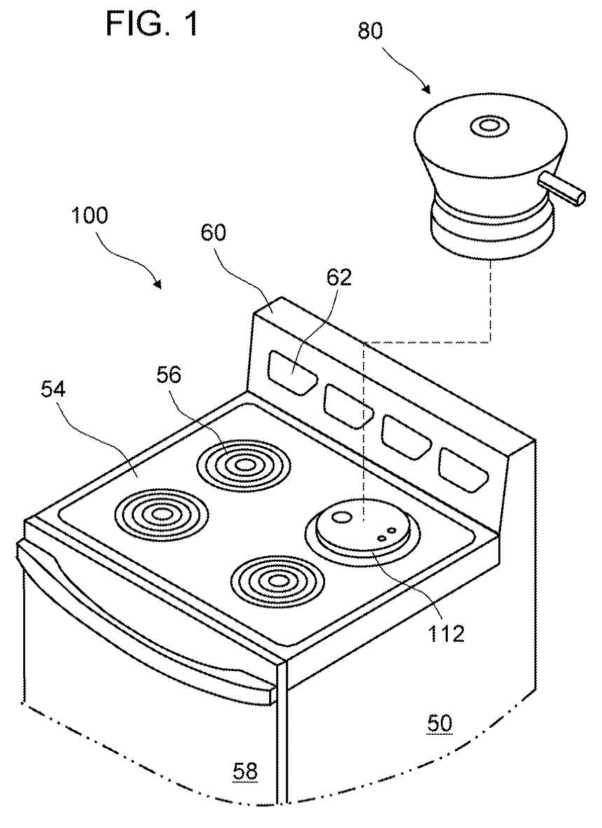

Reference is made to FIG. 1, which illustrates a perspective view of an embodiment of the present invention, a cooking range 100.

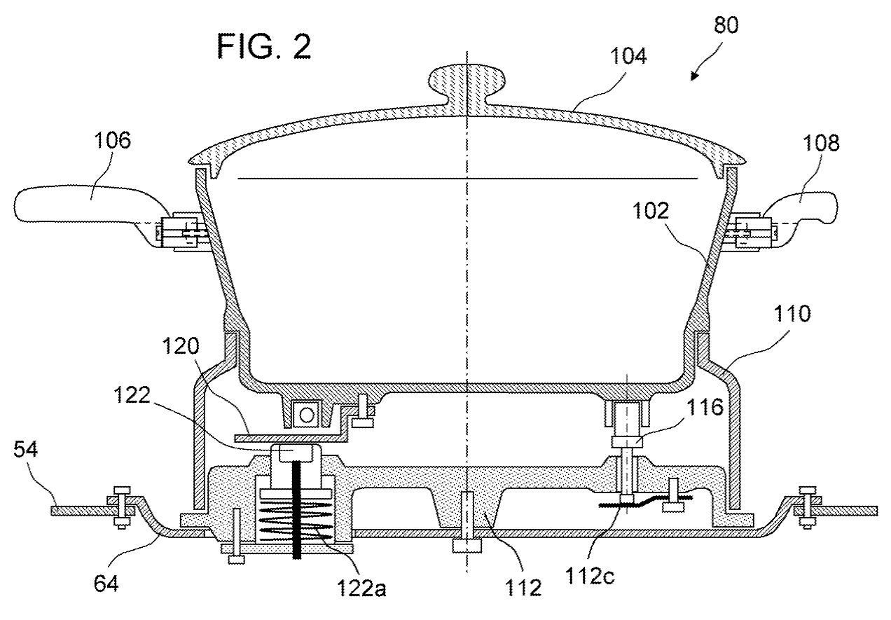

A cabinet 60 is provided for housing an oven (not shown). A range top 54 is installed on top of cabinet 60 for providing a cooking platform, on which are disposed a plurality of cooking stoves, generally designated as 56. Cabinet 50 further includes an oven door 58, which provides access to the oven. Also, a control panel 60 extends from cabinet 50 at the rear of range top 64 and includes a variety of user input devices 62 for controlling the operation of range top 54 and the oven. At least one stove base 112 is disposed on range top 64 for supporting a cooking device 80 to cook food. Cooking device 80 can be designed as a stow cooker, a fondue pot, a hot pot, a kitchen kettle, a deep-fryer, a pressure cooker, a skillet, a wok, a grill or a grill pan, a waffle maker, etc., to meet consumers' cooking needs. Endless cooking devices can be adapted to stand on range top 54. An example of cooking device 80, a universal cooker, is illustrated in FIG. 2, which illustrates a cross-sectional view of cooking device 80.

A container 102, having an open top and a sidewall, is provided for holding and cooking food. The sidewall of container 102 is slightly tapered with a larger diameter on the top and a smaller diameter on the bottom. Container 102 is preferably coated with a non-stick material for ease of cleaning after use.

A lid 104 is provided for closing the open top of container 102. Lid 104 is, preferably, made from a transparent material.

A grasp handle 106 and a lift handle 108 are fixedly installed on the upper portion of the sidewall of container 102 for use of handling container 102. Handle 106 can be either generally straight or curved, like a handle for a pitcher, based on specific design or application requirements, as known to those skilled in the art.

An adapting member 110, having a generally tapered hollow cylindrical configuration, is provided for supporting container 102. The upper end of member 110 is fixedly engaged with the periphery of the bottom portion of container 102 and the lower end is extended downward to a predetermined distance, such that container 102 is adapted to stand on stove base 112 for cooking purposes, or on a horizontal countertop or a dinning table for serving food. Member 110 is, preferably, made from a non-metal material of low thermal conductivity, such that container 102 can directly stand on a dinning table without the risk of overheating the same. Since the upper end of member 110 is engaged with the bottom portion of container 102, the material for member 110 should be of high thermal resistance. However, other materials are readily applicable, such as metal materials, as known to those skilled in the art and suggested by this invention disclosure. Member 110 is provided also for enclosing the space underneath the bottom of container 102 into a protected space for safety consideration.

Stove base 112 is provided on range top 54 for supporting container 102. The upper portion of stove base 112 removably receives the lower end of adapting member 110. Stove base 112 is fixedly installed on top of range top 64 through an adapting plate 64. Stove base 112 is, preferably, made from a non-metal material, such as a ceramic material or a plastic material of high thermal resistance.

An electrical heating tube 116, having a generally circular configuration, is provided for heating food disposed inside container 102. Heating tube 116 is fixedly installed on the outside surface of the bottom of container 102, inserted into a groove formed on the bottom, and disposed dose to the periphery of the bottom with a predetermined distance. The two electrical terminals of heating tube 116 are extended downward to a predetermined distance and are adapted to removably engage with an electrical power supply, as container 102 is installed in position on stove base 112. There are significant advantages of installing heating tube 116 directly on the bottom of container 102. These advantages include saving a significant amount of material for building a full heater that has a thermal diffusion plate, resulting in space and Cost saving, higher heat transfer efficiency, etc. Other heating mechanisms are readily applicable, such as induction heating, as known to those skilled in the art and suggested by this invention disclosure.

A thermo plate 120, made from a metal material of high thermal conductivity, is fixedly installed on the bottom of container 102, at a location substantially close to heating tube 116, for removably engaging a thermostat 122. Thermostat 122 is installed on stove base 112 and removably engaged with thermo plate 120 for detecting the temperature of the bottom of container 102, as container 102 is installed in position on stove base 112. Such temperature is used to control the electrical power to heating tube 116. The upper end of thermostat 122 protrudes upward above the upper surface of stove base 112 with pre-loading, e.g., biased via a spring member 122a. Thermostat 122 can be a digital sensor, such as a NTC or PTC, or an adjustable thermostat, or simply a temperature switch, as known to those skilled in the art and suggested by this invention disclosure.

Container 102 is adapted to stand on stove base 112 to be used as a pan for cooking food. As container 102 is properly installed in position on stove base 112, thermostat 122 is engaged with thermo plate 120, or directly with the bottom of container 102, and the electrical terminals of heating tube 116 are connected with an electrical port 112c that is installed on stove base 112.

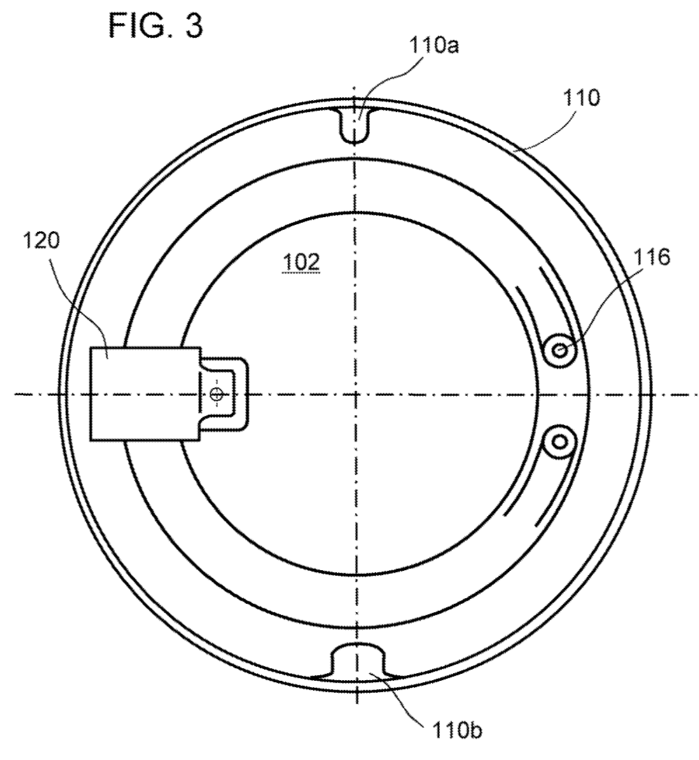

FIG. 3 illustrates a bottom view of container 102 to depict the general layout of various components disposed on the bottom. Two position guides, generally designated as 110a and 110b, protrude inward a predetermined distance from the inner surface of adapting member 110 for guiding container 102 in position on stove base 112 and for preventing container 102 from rotating with respect to stove base 112.

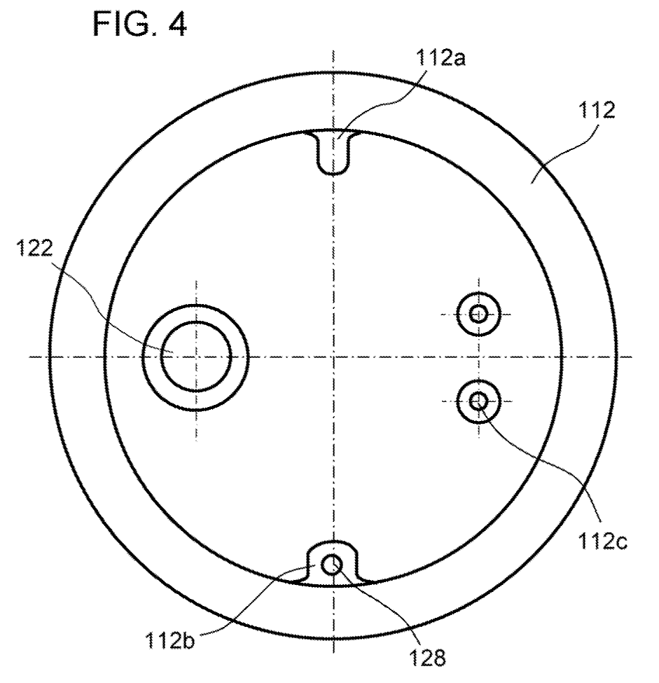

FIG. 4 illustrates a top view of stove base 112 to depict the general layout of various components disposed on the top. Two base guides, generally designated as 112a and 112b, are provided for removably receiving position guides 110a and 110b, respectively. Electrical port 112c is disposed on top of stove base 112 for removably receiving the electrical terminals from heating tube 116, such that electrical power from stove base 112 can be provided to heating tube 116, as container 102 is installed in position on stove base 112. An in-position detector 128 is installed on stove base 112 for detecting whether container 102 is properly installed or not.

Detector 128 is disposed at the bottom of base guide 112b. The upper end of detector 128 protrudes a predetermined distance above the bottom of guide 112b, such that when container 102 is installed in position on stove base 112, the lower end of position guide 110b would press with a force on detector 128 to confirm that container 102 is well positioned. Detector 128 is a switch device, which deactivates heating tube 116 if container 102 is not properly installed on stove base 112.

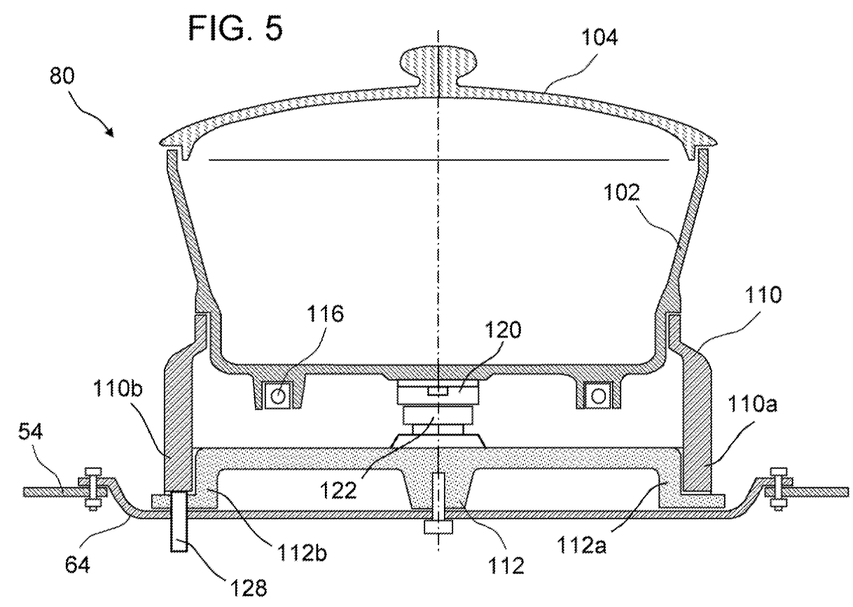

FIG. 5 illustrates another cross-sectional view of cooking device 80 to better describe how container 102 is installed on stove base 112. Position guides 110a and 110b are inserted into base guides 112a and 112b, respectively, such that container 102 is removably locked in position on stove base 112, limiting the rotation of container 102 with respect to stove base 112.

Container 102 can have various designs, varying the depth, or the upper diameter, or both, to be adapted for various applications, such as designed as slow cooking pans, fondue pots, hot pots, kitchen kettles, deep-frying pans, skillet pans, woks, grill pans, pressure cooker pan, etc. While different pans are used, stove base 112 remains the same. This invention disclosure establishes a bridge between large appliances, such as cooking ranges, and small kitchen appliances as mentioned previously, leveraging cooking range resources currently in consumers' home.

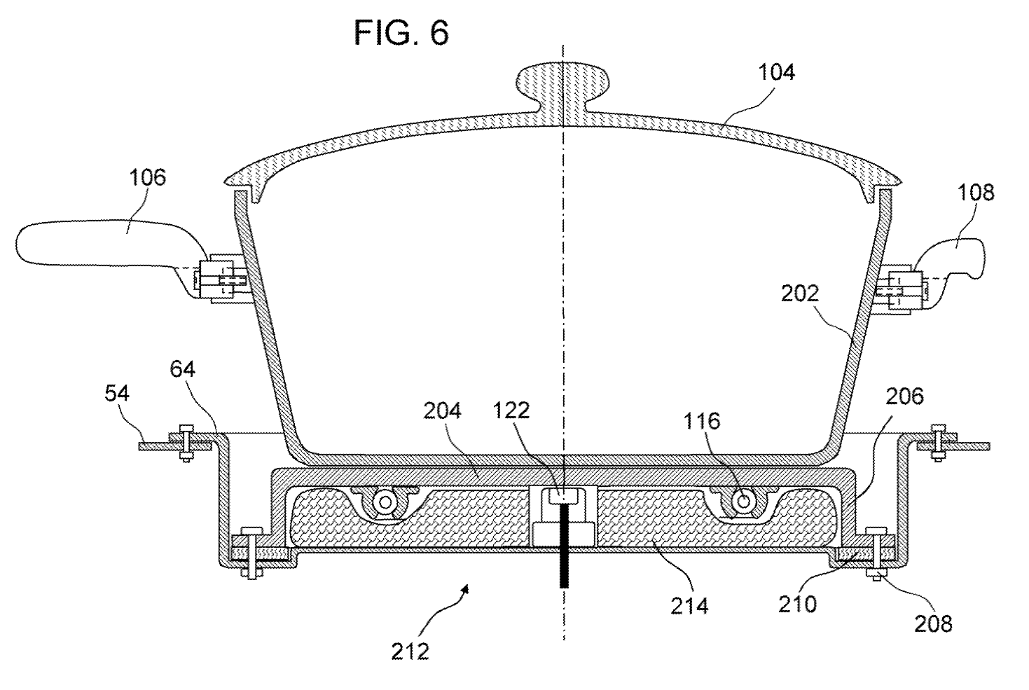

FIG. 6 illustrates a cross-sectional view of an alternative design of stove base 112, a stove base 212. Some components or devices are similar. Similarity is in the sense of both functionality and configuration. Therefore, similar components or devices are denoted with similar reference numbers to avoid repetitive explanations. Reference is made to stove base 112 for detailed information on these similar components or devices.

Stove base 212 includes a heater with a thermal diffusion plate 204, having a disc-shape configuration and a predetermined thickness. Plate 204 is provided for thermal diffusion and for supporting and heating a cooking utensil 202. Plate 204 is preferably made from a metal material of high thermal conductivity. Heating tube 116 is fixedly installed on the bottom of plate 204 for providing heating power. Thermostat 122 is installed on the bottom of plate 204 for detecting and limiting the temperature of plate 204.

A heater sidewall 206 extends from the peripheral outer rim of plate 204 downward to a predetermined distance and is sealingly installed on the bottom of adapting plate 64. Sidewall 206 is provided for enclosing the space underneath plate 204. Sidewall 206 can be an integral part of plate 204, or a separate part engaged with plate 204. The lower end of sidewall 206 is fixedly engaged with the bottom of adapting plate 64 through a plurality of bolts 208.

A ring shaped thermal insulation member 210 is installed in between the lower end of sidewall 206 and the bottom of adapting plate 64 for preventing heat from transferring from plate 204 to adapting plate 64 through sidewall 206, thereby reducing heat loss and avoiding overheating of adapting plate 64.

A thermal insulation material 214 is inserted into the space enclosed by plate 204, sidewall 206, and the bottom of adapting plate 64 to reduce heat loss.

Various cooking utensils can be used for cooking food on top of stove base 212 or thermal diffusion plate 204, with automatic and more precise temperature control, such that stove base 212 can be adapted for various cooking applications, such as slow cooking, simmering, boiling, steaming, braising, sautéing, deep frying, pressure cooking, etc.

Accordingly, readers will see that this cooking range of the present invention includes a cooking device or a utensil that can be adapted to stand on a stove base on top of the range top for cooking purposes. The cooking device is removable from the stove base, such that the cooking device is convenient for cleaning after use and dishwasher safe. Many cooking devices of various applications share one common stove base, such that consumers do not have to buy many small kitchen appliances for their cooking needs, and instead, they are able to buy various cooking devices or utensils, as accessories, which are much less expensive than full appliances.

The present invention has been described in an illustrative manner. It is to be understood that the terminology, which has been used, is intended to be in the nature of words of description rather than of limitation.

Although this invention has been described in its preferred forms and structures with a certain degree of particularity, these should not be construed as limiting the scope of the invention but as merely providing illustrations of some of the presently preferred embodiments of this invention.

Thus it is understood that the present disclosure of the preferred forms can be changed in the details of construction and in the combination and arrangement of parts without departing from the spirit and the scope of the invention as hereinafter claimed.

What is claimed is:

1. A cooking range, said cooking range comprising:
a range top for supporting cooking stoves;
a control panel for controlling the operation of said cooking range;
at least one stove base installed on top of said range top for supporting a cooking device; and
a thermostat installed on said at least one stove base for detecting and limiting the temperature of the bottom of said cooking device.

2. A cooking range as defined in claim 1, wherein said thermostat is biased with a spring member, the upper end of said thermostat protrudes upward above the upper surface of said at least one stove base, when said cooking device is disposed in position on said at least one stove base the probing head of said thermostat is adapted to engage with the bottom of said cooking device for detecting and limiting the temperature of the bottom of said cooking device, and whereby more accurate cooking temperature can be achieved and maintained.

3. A cooking range as defined in claim 1, wherein said at least one stove base includes an electrical port installed on top of said at least one stove base for providing electrical power to said cooking device, as said cooking device is installed in position on said at least one stove base.

4. A cooking range, said cooking range comprising:
a range top for supporting cooking stoves;
a control panel for controlling the operation of said cooking range;
a cooking device disposed on top of said range top for cooking food;
at least one stove base installed on top of said range top for supporting said cooking device;
an adapting member fixedly engaged with said cooking device for adapting said cooking device to removably stand on said at least one stove base;
a thermostat installed on said at least one stove base for detecting and limiting the temperature of the bottom of said cooking device; and
wherein said cooking device is removable from said at least one stove base.

5. A cooking range as defined in claim 4, wherein said thermostat is biased with a spring member, the upper end of said thermostat protrudes upward above the upper surface of said at least one stove base, and when said cooking device is disposed in position on said at least one stove base said thermostat is adapted to be engaged with the bottom of said cooking device.

6. A cooking range as defined in claim 4, wherein said thermostat is biased with a spring member, a thermo plate is fixedly installed on the bottom of said cooking device at a location substantially close to a heating element, the upper end of said thermostat protrudes upward above the upper surface of said at least one stove base, and when said cooking device is disposed in position on said at least one stove base said thermostat is adapted to be engaged with said thermo plate.

7. A cooking range as defined in claim 4, wherein said adapting member includes at least one position guide for guiding said cooking device in position on said at least one stove base and for preventing said cooking device from rotating with respect to said at least one stove base.

8. A cooking range as defined in claim 4, wherein said adapting member has a generally hollow cylindrical configuration, the upper end of said adapting member is routed over the lower portion of said cooking device and is fixedly engaged thereof, and the lower end of said adapting member is routed over the upper portion of said at least one stove base and is removably engaged thereof.

9. A cooking range as defined in claim 4, wherein said cooking device includes heating means fixedly installed on the bottom of said cooking device for heating food and the electrical terminals of said heating means are adapted to be removably engaged with an electrical port disposed on said at least one stove base for supplying electrical power to said heating means, as said cooking device is installed in position on said at least one stove base.

10. A cooking range as defined in claim 4, wherein said at least one stove base includes an in-position detector installed on said at least one stove base for detecting whether said cooking device is properly installed on said at least one stove base or not and wherein if said cooking device is not properly installed on said at least one stove base said in-position detector shuts off electrical power to said cooking device for safety consideration.

11. A cooking range as defined in claim 4, wherein said cooking device includes:
a container having an open top and a sidewall for holding and cooking food;
a lid for closing the open top of said container;
heating means for heating food disposed inside said container; and
wherein said heating means is fixedly installed on the bottom of said container.

12. A cooking range as defined in claim 11, wherein said adapting member includes an upper end and a lower end, the upper end is fixedly engaged with the periphery of the lower portion of said container, and the lower end is extended downward to a predetermined distance and is removably engaged with said at least one stove base.

13. A cooking range as defined in claim 11, wherein said adapting member includes at least one position guide for guiding said container in position on said at least one stove base and for preventing said container from rotating with respect to said at least one stove base.

14. A cooking range as defined in claim 11, wherein said adapting member has a generally hollow cylindrical configuration, the upper end of said adapting member is routed over the lower portion of said container and is fixedly engaged thereof and the lower end of said adapting member is routed over the upper portion of said at least one stove base and is removably engaged thereof.

15. A cooking range as defined in claim 11, wherein said heating means includes a heating tube of a generally circular configuration, said heating tube is fixedly installed inside a groove formed on the bottom of said container, and said heating tube is disposed close to the periphery of the bottom of said container with a predetermined distance.

16. A cooking range as defined in claim 11, wherein said heating means includes a heating tube of a generally circular configuration, said heating tube is welded on the bottom of said container, and said heating tube is disposed close to the periphery of the bottom of said container with a predetermined distance.

17. A cooking range as defined in claim 11, wherein the electrical terminals of said heating means are adapted to be removably engaged with an electrical port disposed on said at least one stove base for supplying electrical power to said heating means, as said container is installed in position on said at least one stove base.

18. A cooking range, said cooking range comprising:
a range top for supporting cooking stoves;
a control panel for controlling the operation of said cooking range, at least one stove base installed on top of said range top for supporting a cooking utensil;
wherein said at least one stove base includes an electrical heater having a thermal diffusion plate and a heating tube and said heating tube is installed on the bottom of said thermal diffusion plate for providing heating power; and
a thermostat installed on the bottom of said thermal diffusion plate for detecting and limiting the temperature of said electrical heater.

19. A cooking range as defined in claim 18, wherein said electrical heater includes a sidewall extended downward from the peripheral outer rim of said thermal diffusion plate to a predetermined distance, the lower end of said sidewall is fixedly installed on said range top, such that the space underneath said thermal diffusion plate is contained, and whereby food debris or cooking liquids are prevented from dropping or flowing into the space under said thermal diffusion plate.

20. A cooking range as defined in claim 19, wherein a thermal insulation material is inserted inside the space enclosed by said thermal diffusion plate, said sidewall, and the upper surface of said range top for thermal insulation.
